(19) United States
(12) Patent Application Publication
(10) Pub. No.: US 2015/0092127 A1
(43) Pub. Date: Apr. 2, 2015

(54) LIQUID CRYSTAL DISPLAY DEVICE

(71) Applicant: Japan Display Inc., Minato-ku (JP)

(72) Inventor: Toshimasa YONEKURA, Tokyo (JP)

(73) Assignee: Japan Display Inc., Minato-ku (JP)

(21) Appl. No.: 14/504,521

(22) Filed: Oct. 2, 2014

(30) Foreign Application Priority Data
Oct. 2, 2013 (JP) 2013-207393

(51) Int. Cl. G02F 1/1362; G02F 1/1343

(52) U.S. Cl. CPC G02F 1/136213; G02F 1/136286; G02F 1/134336
USPC 349/39

(57) ABSTRACT

According to one embodiment, a liquid crystal display device includes an array substrate including pixel electrodes arranged in a matrix, a opposite substrate including a opposite electrode opposing the pixel electrodes, and a liquid crystal layer held between the array opposite substrates. The array substrate includes first and second gate lines provided for pixel electrodes of one row on opposite sides of columns, source lines extending along every two columns between the pixel electrodes, first and second pixel switches connected to the respective pixel electrodes adjacent along the one row, and a auxiliary capacitive line opposing, via an insulating film, electrodes of the first and second pixel switches close to the pixel electrodes, and windingly extending along three sides of each pixel electrode to extend along the one row.

### CROSS-REFERENCE TO RELATED APPLICATIONS

This application is based upon and claims the benefit of priority from Japanese Patent Application No. 2013-207393, filed Oct. 2, 2013, the entire contents of which are incorporated herein by reference.

### FIELD

Embodiments described herein relate generally to a liquid crystal display device.

### BACKGROUND

Liquid crystal display devices as flat display devices are now being used in various fields, taking advantage of features, such as light, thin and low power consumption. These liquid crystal display devices each have a structure in which a liquid crystal layer is held between a pair of substrates. Images are displayed by controlling the rate of modulation on the light passing through the liquid crystal layer between each pixel electrode and a common electrode.

In accordance with the increase in the resolution of liquid crystal displays, the number of display pixels is increasing, and the number of driver lines is also increasing. When the driver lines are increased, the resultant driving circuit becomes expensive, which makes it difficult to suppress the manufacturing cost of the liquid crystal display device. As a countermeasure for this, it has been proposed to lay out pixels using a dual-gate structure in which two gate lines are provided for each row.

### SUMMARY

In accordance with an embodiment, there is provided a liquid crystal display device comprising: an array substrate including a plurality of pixel electrodes arranged in rows and columns; a opposite substrate including a opposite electrode opposing the pixel electrodes; and a liquid crystal layer held between the array substrate and the opposite substrate. The array substrate further includes: a first gate line provided for pixel electrodes included in the plurality of pixel electrodes and extending along one of the rows on one side of a direction of the columns; a second gate line extending along the one row on another side of the direction of the columns; source lines extending along every two of the columns between the plurality of pixel electrodes; a first pixel switch connected between one of two pixel electrodes included in the plurality of pixel electrodes and adjacent along the one row, and one of the source lines adjacent to the one pixel electrode, the first pixel switch being turned on and off by a gate signal supplied from the first gate line; a second pixel switch connected between the other of the two pixel electrodes, and one of the source lines adjacent to the other pixel electrode, the second pixel switch being turned on and off by a gate signal supplied from the second gate line; and a auxiliary capacitive line opposing, via an insulating film, electrodes of the first and second pixel switches close to the pixel electrodes, and windingly extending along three sides of each of the pixel electrodes to extend along the one row.

### BRIEF DESCRIPTION OF THE DRAWINGS

FIG. 1 is a schematic view showing a structure example of a liquid crystal display device according to a first embodiment;

FIG. 2 is a schematic view showing a structure example of display pixels in the liquid crystal display device of FIG. 1;

FIG. 3 is a schematic cross-sectional view taken along line I-I′ of FIG. 2;

FIG. 4 is a view for explaining an example of a method of driving the liquid crystal display device of FIG. 1;

FIG. 5 is a schematic view showing a structure example of display pixels in a liquid crystal display device according to a second embodiment;

FIG. 6 is a schematic view showing another structure example of display pixels in the liquid crystal display device of the second embodiment; and

FIG. 7 is a schematic view showing a structure example of display pixels in a liquid crystal display device according to a third embodiment.

### DETAILED DESCRIPTION

When laying out pixels using a dual-gate structure, it is necessary to arrange the TFTs of laterally adjacent two pixels in upper and lower positions. If the positions of auxiliary capacitance areas (Cs) are biased to one side, it is necessary to form auxiliary capacitive electrodes so that pixels having TFT portions separate from each other will be brought into contact with pixel electrodes to secure capacitance. In this case, areas for enabling auxiliary capacitive electrodes to contact respective pixel electrodes are required, which inevitably increases shaded areas and reduces the aperture ratio. Further, in IPS pixels, their pixel electrodes are thin, and therefore adverse influence due to pixel electrode disconnection may well occur. If disconnection of pixel electrodes has occurred, the auxiliary capacitance areas (Cs) cannot hold charges, and such disconnection-occurred portions are regarded as point defects.

In light of the above, the embodiments provide a liquid crystal display device capable of suppressing reduction of an aperture ratio that will occur when a auxiliary capacitance is formed.

A liquid crystal display according to embodiments will be described hereinafter with reference to the drawings.

### First Embodiment

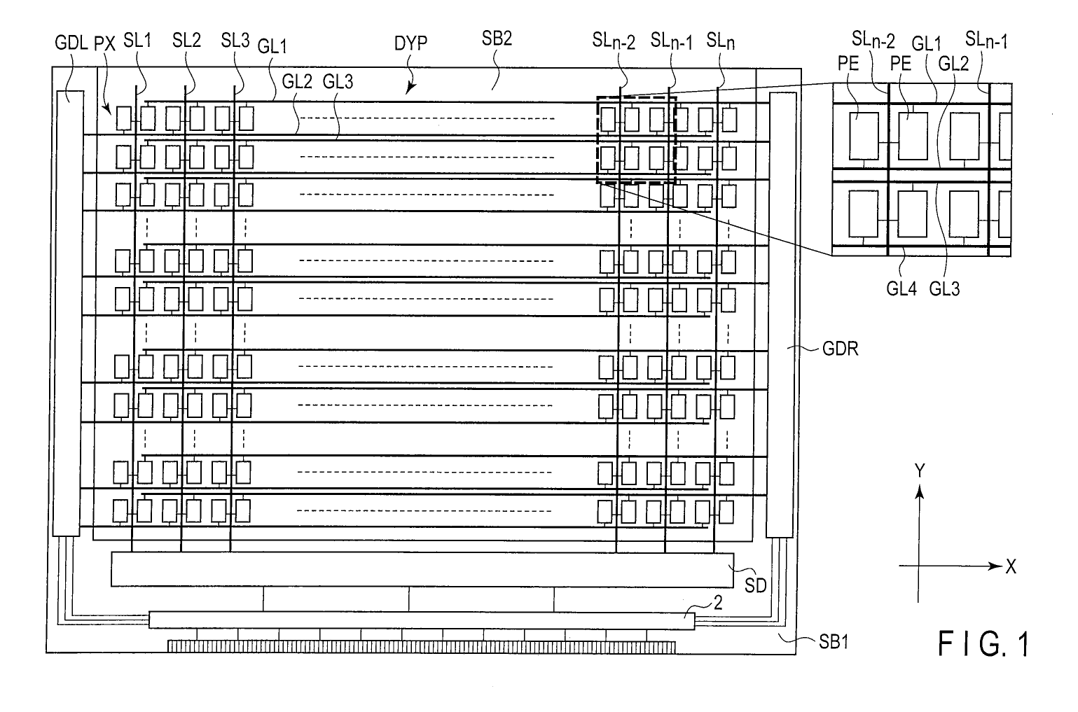

FIG. 1 is a schematic view showing a structure example of a liquid crystal display device according to a first embodiment.

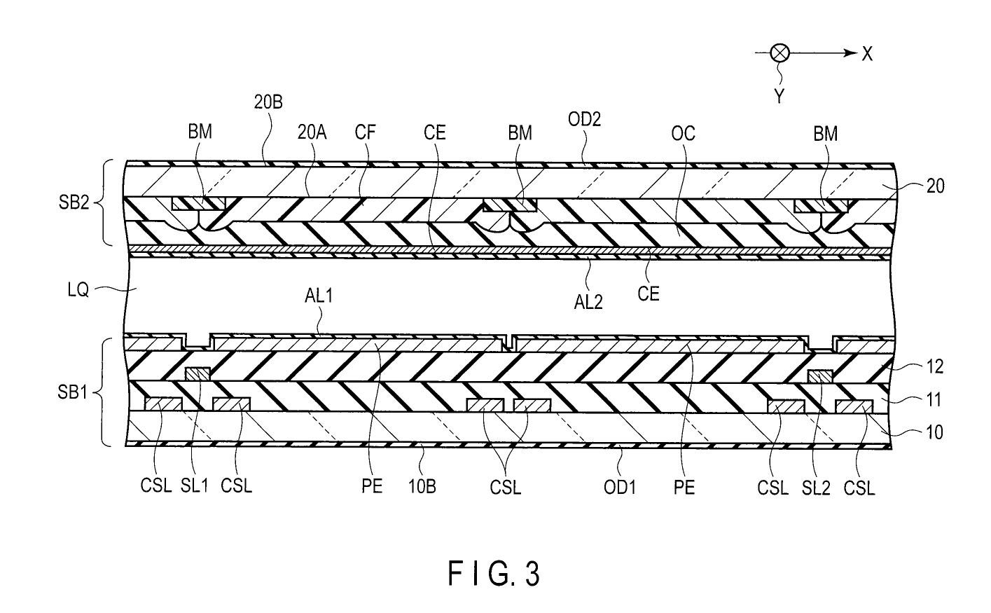

The liquid crystal display device of the first embodiment comprises an array substrate SB1, a opposite substrate SB2 opposing the array substrate SB1, a liquid crystal layer (see FIG. 3) held between the array substrate SB1 and the opposite substrate SB2, and a display unit DYP including a plurality of display pixels PX arranged in a matrix. In the example of FIG. 1, the display pixels PX are arranged in a matrix of m rows and 2n columns (m and n are positive integers).

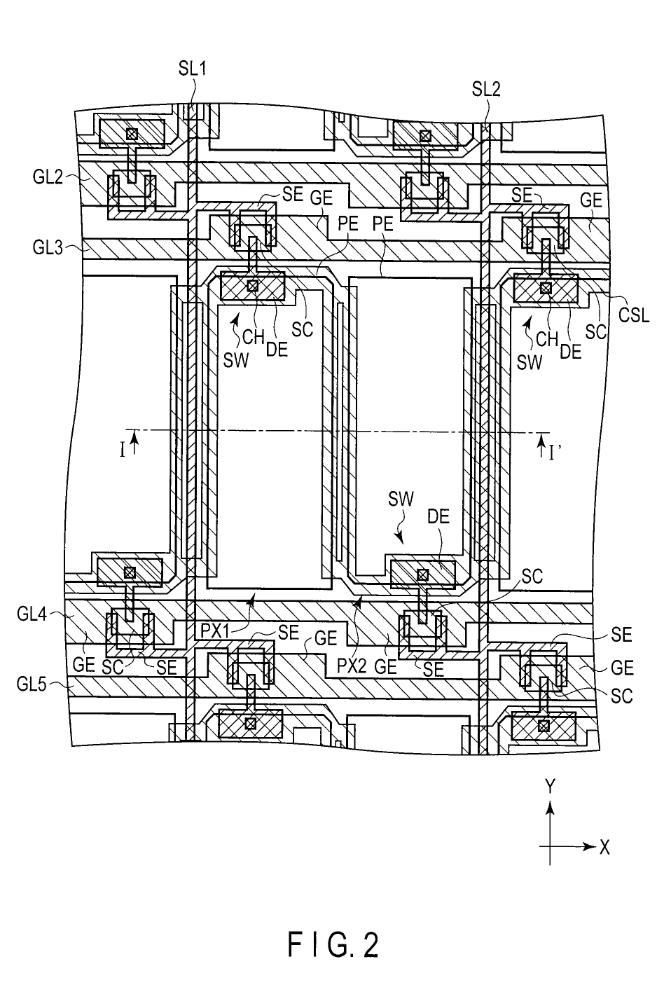

On the display unit DYP, the array substrate SB1 comprises pixel electrodes PE provided for the respective display pixels, gate lines GL (GL1, GL2, . . . , GL2m) extending along the rows (along an X axis) of the pixel electrodes PE, source lines SL (SL1, SL2, . . . , SLn) extending along the columns (along a Y axis) of the pixel electrodes PE, and pixel switches (see FIG. 2) arranged near positions in which the respective gate lines GL intersect the source lines SL.

The array substrate SB1 also comprises a driving circuit provided around the display unit DYP, and a driving IC chip 2 including a built-in controller. The driving circuit comprises gate drivers GDL and GDR for driving the gate lines GL, and a source driver SD for driving the source lines SL. At least part of the gate drivers GDL and GDR and source driver SD is formed on, for example, the array substrate SB1 and connected to the driving IC chip 2 including the built-in controller.

The gate driver GDL is provided on one side (i.e., the left side) of rows of the display unit DYP. The gate driver GDR is provided on the other side (i.e., the right side) of rows of the display unit DYP. The gate driver GDL is electrically connected to gate lines of even numbers, i.e., GL2, GL4, . . . , GL2m. Similarly, the gate driver GDR is electrically connected to gate lines of odd numbers, i.e., GL1, GL3, . . . , GL2m−1. The gate drivers GDL and GDR sequentially output driving signals to the gate lines GL, based on a clock signal and a horizontal synchronization signal, etc., received from the driving IC chip 2.

The source driver SD is provided on one side of a direction in which columns of the display unit DYP are arranged. The source driver SD is electrically connected to the source lines SL. The source driver SD outputs corresponding video signals to the source lines SL, based on a clock signal and a vertical synchronization signal, etc., received from the driving IC chip 2.

The opposite substrate SB2 comprises a common electrode (see FIG. 3) provided on the display unit DYP. The common electrode opposes the pixel electrodes PE.

FIG. 2 schematically shows a structure example of display pixels in the liquid crystal display device of FIG. 1.

As shown in FIG. 2, the gate lines GL extend along and between the rows of the pixel electrodes PE. In the liquid crystal display device of the first embodiment, the gate lines GL are arranged on opposite sides (i.e., the upper and lower sides), with respect to columns, of the pixel electrodes PE arranged along the rows. In other words, two gate lines GL are provided between each pair of adjacent rows of pixel electrodes PE.

The source lines SL extend along and between the columns of the pixel electrodes PE. In the liquid crystal display device of the first embodiment, the source lines SL are arranged at every two columns.

FIG. 2 schematically shows an area including the intersections of the source lines SL1 and SL2 and the gate lines GL3 and GL4. In the description below, among the display pixels arranged in the area surrounded by the source lines SL1 and SL2 and the gate lines GL3 and GL4, the display pixels close to the source line SL1 will be referred to as PX1, while the display pixels close to the source line SL2 will be referred to as PX2.

The pixel electrode PE of the display pixel PX1 is connected to the source line SL1 via a pixel switch (first pixel switch) SW provided near the intersections of the gate line (first gate line) GL3 and the source line SL1. Namely, the connection, to the source line SL1, of the pixel electrode PE of the display pixel PX1 can be switched via a pixel switch SW located in the upper portion of the figure.

The pixel switch SW is formed of, for example, a thin film transistor (TFT). The thin film transistor comprises a gate electrode GE, a source electrode SE, a drain electrode DE, and a semiconductor layer SC formed of amorphous silicon.

The semiconductor layer SC is provided on the gate electrode GE via an insulation layer. The gate electrode GE is formed in the same layer as that containing the gate line GL, and the source electrode SE and the drain electrode DE are formed in the same layer as that containing the source line SL.

In the display pixel PX1, the gate electrode GE is electrically connected to the gate line GL3 (or the gate electrode GE is formed integral with the gate line GL3). The source electrode SE is electrically connected to the source line SL1 (or the source electrode SE is formed integral with the source line SL1). The drain electrode DE is electrically connected to the pixel electrode PE (or the drain electrode DE is formed integral with the pixel electrode PE). The drain electrode DE is electrically connected to the pixel electrode PE via a contact hole CH formed in the lower portion of the pixel electrode PE, and is extended upwardly in the figure from the lower portion of the pixel electrode PE to the semiconductor layer SC.

The pixel electrode PE of the display pixel PX2 is connected to the source line SL2 via a pixel switch (second pixel switch) SW provided near the intersections of the gate line (second gate line) GL4 and the source line SL2. Namely, the connection, to the source line SL2, of the pixel electrode PE of the display pixel PX2 can be switched via a pixel switch SW located in the lower portion of the figure.

In the display pixel PX2, the gate electrode GE is electrically connected to the gate line GL4 (or the gate electrode GE is formed integral with the gate line GL4). The source electrode SE is electrically connected to the source line SL2 (or the source electrode SE is formed integral with the source line SL1). The drain electrode DE is electrically connected to the pixel electrode PE. The drain electrode DE is electrically connected to the pixel electrode PE via a contact hole CH in the lower portion of the pixel electrode PE, and is extended downwardly in the figure from the lower portion of the pixel electrode PE to the semiconductor layer SC.

Namely, in the first embodiment, the pixel electrode PE of the display pixel PX1 is electrically connected via the pixel switch SW to the source line SL1 located on the left side. Further, the pixel electrode PE of the display pixel PX2 is electrically connected via the pixel switch SW to the source line SL2 located on the right side.

In other words, display pixels having the same structure as the first display pixel PX1, and display pixels having the same structure as the second display pixel PX2, are alternately arranged along the row. Further, along the row, the source lines SL are electrically connected to the respective pixel electrodes PE of the display pixels PX via the respective pixel switches SW.

By virtue of the above structure, the source driver SD can drive the display pixels PX of the 2n columns, using n source lines SL1 to SLn. As a result, the liquid crystal display device of the embodiment can be realized without using an expensive source driver SD.

The array substrate SB1 further comprises a auxiliary capacitive line CSL that partially overlaps with the pixel electrodes PE via insulating films (see FIG. 3) along the thickness of the substrate (i.e., along an axis substantially perpendicular to the rows and columns). The auxiliary capacitive line CSL is electrically connected to a voltage apply unit (not shown) to which a auxiliary capacitive voltage is applied.

In each row, the auxiliary capacitive line CSL is windingly extended along three ends (sides) of each pixel electrode PE. Thus, the auxiliary capacitive line CSL encloses each pixel electrode PE along three sides of the same. Further, the auxiliary capacitive line CSL overlaps with three sides of each pixel electrode PE, and has an opening in a position between adjacent pixel electrodes at which the auxiliary capacitive line CSL overlaps with a corresponding source line SL.

In the display pixel PX1, the pixel electrode PE opposes the auxiliary capacitive line CSL at ends of the electrode extending substantially parallel to the column, and at an upper end of the same extending substantially parallel to the row. The upper end of the display pixel PX1 overlaps with the drain electrode DE of the pixel switch SW.

In contrast, in the display pixel PX2, the pixel electrode PE opposes the auxiliary capacitive line CSL at ends of the electrode extending substantially parallel to the column, and at a lower end of the same extending substantially parallel to the row. The lower end of the display pixel PX2 overlaps with the drain electrode DE of the pixel switch SW.

Namely, the auxiliary capacitive line CSL opposes a respective pixel electrode PE at the right and left ends of the pixel electrode and at the upper or lower end of the same connected to the corresponding pixel switch SW. This is equivalent to a structure in which auxiliary capacitance areas are arranged in upper and lower positions between adjacent pixel electrodes in accordance with the positions of the respective TFTs.

FIG. 3 is a schematic cross-sectional view of the liquid crystal display device taken along line I-I′ of FIG. 2. FIG. 3 shows only portions needed for the description.

A backlight (not shown) is provided on the backside of the array substrate SB1 incorporated in the liquid crystal display device. Various types of lights may be used as the backlight. Further, a light emission diode (LED) and a cold-cathode tube (CCFL) may be used as a light source. No detailed description will be given of the structure of the backlight.

The array substrate SB1 is formed of a first insulating substrate 10 having a light transmission. The auxiliary capacitive line CSL is formed on the first insulating substrate 10. The source lines SL are formed on a first interlayer insulating film 11 and covered with a second interlayer insulating film 12. The gate lines (not shown) are formed, for example, in the same layer as that containing the auxiliary capacitive line CSL, and are arranged between the first insulating substrate 10 and the first interlayer insulating film 11. The pixel electrodes PE are formed on the second interlayer insulating film 12. End portions of the pixel electrodes PE oppose the auxiliary capacitive line CSL.

A first oriented film AL1 is provided on a surface of the array substrate SB1 opposing the opposite substrate SB2, and is extended over substantially the entire display unit DYP. The first oriented film AL1 covers the pixel electrodes PE, the second interlayer insulating film 12, etc. The first oriented film AL1 is formed of a material exhibiting a horizontal orientation.

The opposite substrate SB2 is formed using a second insulating substrate 20 with a light transmission. The opposite substrate SB2 comprises black matrices BM, color filters CF, an overcoat layer OC, a common electrode CE, a second oriented film AL2, etc.

The black matrices BM partition the substrate into the display pixels PX and provide openings opposing the pixel electrodes PE. Namely, the black matrices BM are arranged to oppose lines, such as the source lines SL, the gate lines, the auxiliary capacitive line CSL and switching elements. Although the figure shows only portions of the black matrices BM extending along the column, the black matrices BM may have portions extending along the row. The black matrices BM are provided on the inner surface 20A of the second insulating substrate 20 opposing the array substrate SB1.

The color filters CF are opposed to the display pixels PX. More specifically, the color filters CF are provided in the openings in the inner surface 20A of the second insulating substrate 20, and have portions extending onto the black matrices BM. The color filters CF provided for the respective display pixels PX adjacent along the row have different colors. For instance, the color filters CF are formed of resin materials colored in three primary colors of red, blue and green. A red color filter formed of a resin material colored in red is aligned with a red pixel. Similarly, a blue color filter formed of a resin material colored in blue is aligned with a blue pixel. Further, a green color filter formed of a resin material colored in green is aligned with a green pixel. The boundaries of these color filters CF overlap with the black matrices BM.

The overcoat layer OC covers the color filters CF. The overcoat layer OC reduces the influence of the uneven surfaces of the color filters CF.

The common electrode CE is provided on a surface of the overcoat layer OC opposing the array substrate SB1. The common electrode CE opposes a plurality of pixel electrodes PE via the liquid crystal layer LQ.

The second oriented film AL2 is provided on the surface of the opposite substrate SB2 opposing the array substrate SB1, and is extended over substantially the entire display unit DYP. The second oriented film AL2 covers the common electrode CE, the overcoat layer OC, etc. The second oriented film AL2 is formed of a material exhibiting a horizontal orientation.

The first and second oriented films AL1 and AL2 are beforehand subjected to orientation processing (e.g., rubbing processing or optical orientation processing) for initially orienting the liquid crystal molecules of the liquid crystal layer LQ.

The array substrate SB1 and the opposite substrate SB2 are positioned such that the first and second oriented films AL1 and AL2 oppose each other. In this state, columnar spacers (not shown) formed integral with one of the substrates are provided between the first oriented film AL1 of the array substrate SB1 and the second oriented film AL2 of the opposite substrate SB2. As a result, a predetermined cell gap is formed. The array substrate SB1 and the opposite substrate SB2 are attached to each other by a seal member (not shown) outside the display unit DYP, with the predetermined cell gap formed therebetween.

The liquid crystal layer LQ is held in the cell gap defined between the array substrate SB1 and the opposite substrate SB2, and is positioned between the first and second oriented films AL1 and AL2. The liquid crystal layer LQ is formed of a liquid crystal material having, for example, positive dielectric anisotropy.

A first optical device OD1 is attached, by, for example, an adhesive, to the outer surface of the array substrate SB1, i.e., the outer surface 10B of the first insulating substrate 10 constituting the array substrate SB1. The first optical device OD1 is positioned to oppose the backlight of the liquid crystal display device, and is used to control the polarization state of the light emitted from the backlight to the liquid crystal display device. The first optical device OD1 comprises a first polarizing plate (not shown) having a first polarizing axis (or first absorbing axis).

A second optical device OD2 is attached, by, for example, an adhesive, to the outer surface of the opposite substrate SB2, i.e., the outer surface 20B of the second insulating substrate 20 constituting the opposite substrate SB2. The second optical device OD2 is positioned at the display surface side of the liquid crystal display device, and is used to control the polarization state of the light output from the liquid crystal display device. The second optical device OD2 comprises a second polarizing plate (not shown) having a second polarizing axis (or second absorbing axis).

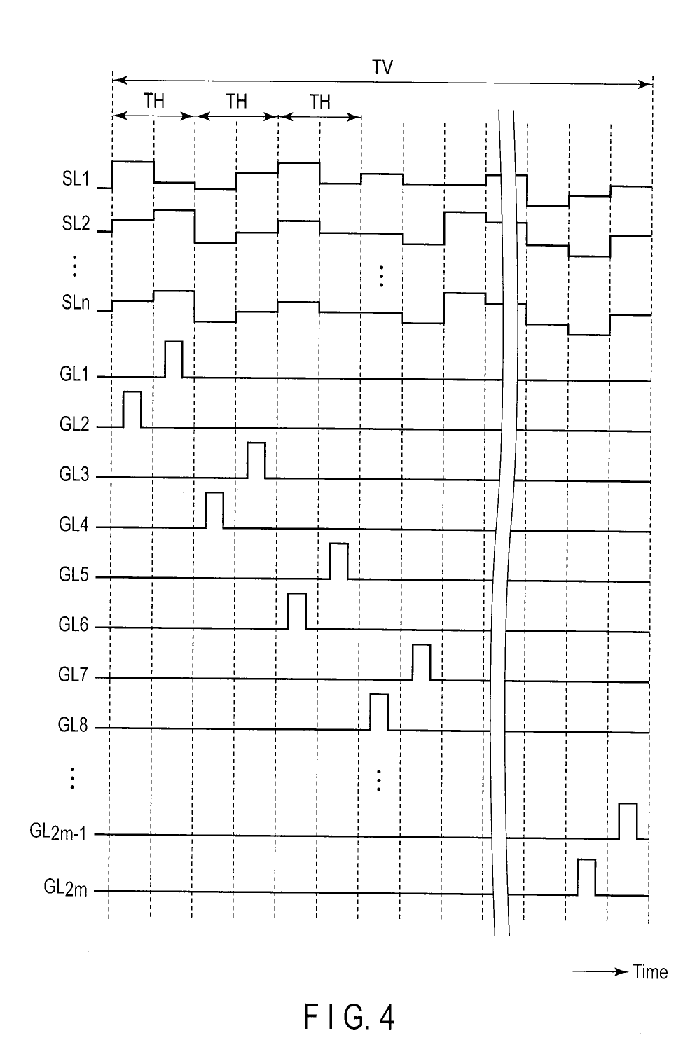

FIG. 4 is a view for explaining an example of a method of driving the above-described liquid crystal display device.

A description will now be given of a method example of driving display pixels PX arranged in a matrix of m rows×2n columns. The gate drivers GDL and GDR and the source driver SD drive display pixels PX of each row in one horizontal period of time TH, and drives display pixels PX of m rows in one vertical period of time TV.

The gate driver GDL sequentially drives gate lines of even numbers, i.e., GL2, GL4, . . . , GL2m in the former half of each horizontal period of time TH. For instance, when the gate driver GDL drives the gate line GL2, the source electrodes SE and the drain electrodes DE of pixel switches SW connected to the left sides of source lines SL in a first row become conductive, whereby video signals are applied by the source lines SL.

The gate driver GDR sequentially drives gate lines of odd numbers, i.e., GL1, GL3, . . . , GL2m−1 in the latter half of each horizontal period of time TH. For instance, when the gate driver GDR drives the gate line GL1, the source electrodes SE and the drain electrodes DE of pixel switches SW connected to the right sides of source lines SL in the first row become conductive, whereby video signals are applied by the source lines SL.

In the former half of one horizontal period of time TH, the source driver SD supplies each source line SL with video signals to be applied to display pixels PX connected to the left side of each source line SL. In the latter half of one horizontal period of time TH, the source driver SD supplies each source line SL with video signals to be applied to display pixels PX connected to the right side of each source line SL.

In other words, in the liquid crystal display device of the first embodiment, the source driver SD can supply video signals to display pixels PX of two columns using one source line SL. Thus, the number of source lines SL driven by the source driver SD is ½, which enables an inexpensive source driver to be employed.

Further, since in the first embodiment, each of the gate drivers GDL and GDR sequentially drives m gate lines GL, it is not necessary to drive the gate lines GL at high speed. This enables the liquid crystal display device of the first embodiment to employ an inexpensive gate driver.

As described above, in the first embodiment, the increase in the manufacturing cost of the liquid crystal display device can be suppressed. In addition, the embodiment can also provide the following advantage by devising the arrangement of the auxiliary capacitive line:

When pixels are laid out using a dual gate structure, it is necessary to arrange the TFTs of laterally adjacent two pixels in upper and lower positions. However, when capacitance areas Cs, which are formed between the auxiliary capacitive line CSL and the drain electrodes, are biased to one side, they cannot directly be formed of the drain electrodes in adjacent pixels whose TFTs are separate from each other. Accordingly, to secure capacitance, it is necessary to form auxiliary capacitive electrodes in contact with pixel electrodes. In this case, areas for enabling the auxiliary capacitive electrodes to contact the pixel electrodes are required, which inevitably increases shaded areas and reduces the aperture ratio.

In contrast, in the first embodiment, the pixel switch of a pixel is provided in an upper position, that of a pixel laterally adjacent to the first-mentioned pixel is provided in a lower position, and a auxiliary capacitive line CLS is extended windingly so that it overlaps with the drain electrodes of the pixel switches, as is shown in FIG. 2. Further, since capacitance areas Cs are formed in accordance with the positions of the TFTs, it is not necessary to provide a contact area, in which each pixel electrode contacts a corresponding capacitance area Cs (auxiliary capacitive electrode) and which is needed when the capacitance areas Cs are biased to one side. Therefore, reduction of an aperture ratio that will occur when a auxiliary capacitance is formed can be controlled.

### Second Embodiment

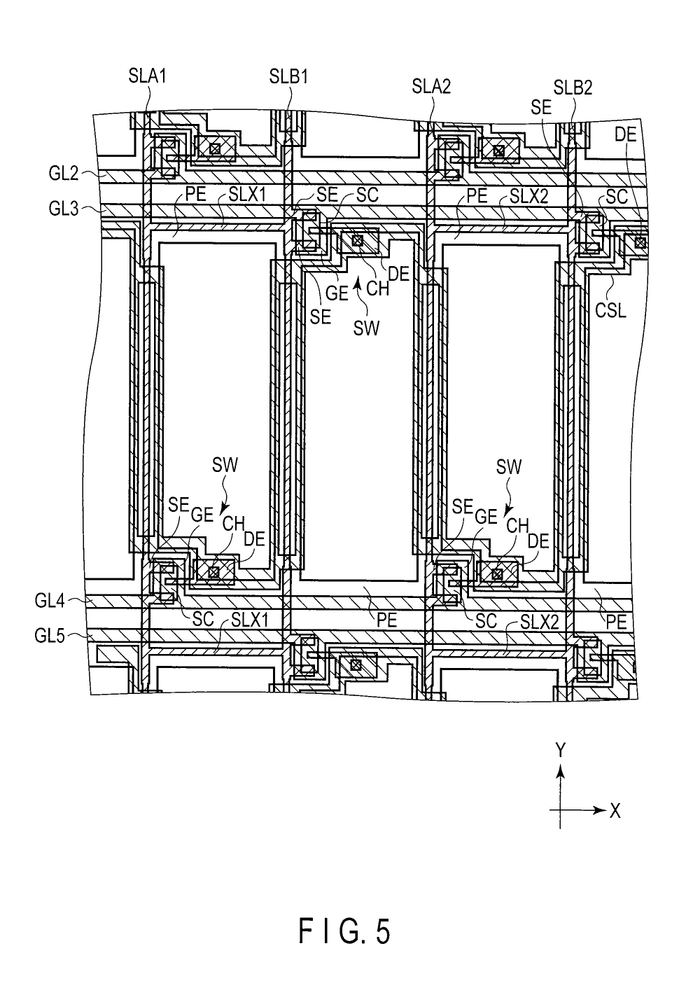

FIG. 5 is a schematic view showing a structure example of display pixels in a liquid crystal display device according to a second embodiment. In FIG. 5, elements similar to those of FIG. 2 are denoted by corresponding reference numbers, and no detailed description will be given thereof.

In the second embodiment, the source lines SL include first source lines SLA (SLA1, SLA2, . . . , SLAn), second source lines SLB (SLB1, SLB2, . . . , SLBn), and connections SLX. Common video signals are supplied from the source driver SD to the first and second source lines SLA and SLB.

The first source lines SLA and the second source lines SLB extend along the columns of the display pixels PX. Further, the first source lines SLA and the second source lines SLB are arranged on the opposite sides (i.e., the right and left sides), with respect to rows, of the pixel electrodes PE arranged in columns.

The connections SLX extend along rows between the pixel electrodes PE arranged in columns, and are electrically connected to the first and second source lines SLA and SLB. More specifically, first and second source lines SLA1 and SLB1 are electrically connected by a plurality of connections SLX. Similarly, first and second source lines SLA2 and SLB2 are electrically connected by a plurality of connections SLX.

Thus, the first and second source lines SLA and SLB are connected by a plurality of connections SLX. In this case, even if part of one of the first and second source lines SLA and SLB is electrically disconnected, video signals can be supplied via the other source line and the connections SLX to display pixels PX positioned downstream of the disconnected portion.

As described above, the second embodiment can provide a liquid crystal display device improved in manufacturing yield as a result of avoiding occurrence of dark and bright lines, and excellent in display quality.

Further, in FIG. 5, although the connections SLX are arranged on opposite sides (i.e., upper and lower sides) of columns of pixel electrodes PE, they may be provided on only one side of a direction in which columns of pixel electrodes PE are arranged. It is sufficient if the first and second source lines SLA and SLB are connected by at least one connection SLX. However, as the number of connections SLX is increased, display defects due to electrical disconnection can be more reliably avoided.

Each pixel switch SW comprises a semiconductor layer SC, a gate electrode GE, a source electrode SE and a drain electrode DE. The semiconductor layer SC is provided on the gate electrode GE via an insulation layer. The gate electrode GE is formed in the same layer as that containing the gate line GL, and the source electrode SE and the drain electrode DE are formed in the same layer as that containing the source line SL.

The gate electrodes GE is electrically connected to the gate line GL (or the gate electrode GE is formed integral with the gate line GL). In the second embodiment, the gate electrode GE of a pixel switch SW positioned near the intersection of the first source line SLA and the gate line GL upwardly extends from the gate line GL along the column. The gate electrode GE of a pixel switch SW positioned near the intersection of the second source line SLB and the gate line GL downwardly extends from the gate line GL along the column.

The source electrode SE is electrically connected to the source line SL (or the source electrode SE is formed integral with the source line SL). The source electrode SE extends rightward along the row from the first and second source lines SLA and SLB, and is provided on part of the semiconductor layer SC. In the example of FIG. 5, the source electrode SE protrudes from the first and second source lines SLA and SLB near the intersection of the first and second source lines SLA and SLB and the gate line GL.

The drain electrode DE is electrically connected to the pixel electrode PE (or the drain electrode DE is formed integral with the pixel electrode PE). The drain electrode DE extends along the row between the upper portion of the semiconductor layer SC and the lower portion of the pixel electrode PE, and is electrically connected to the pixel electrode PE through a contact hole CH formed in position in which the drain electrode DE overlaps with the pixel electrode PE via an insulating layer. In the upper portion of the semiconductor layer SC, the drain electrode DE is interposed between two source electrodes SE.

The liquid crystal display device of the second embodiment is similar to that of the first embodiment except for the above-described structure. In the second embodiment, all display pixels PX are common in the structure of the pixel switch SW. Namely, in all display pixels PX, the source electrode SE extends rightward along the row from the source line SLA or SLB, and the drain electrode DE extends along the row between the lower portion of the pixel electrode PE and the upper portion of the semiconductor layer SC. Accordingly, even if the position of a conductor layer is deviated during forming the array substrate SB1, a capacitance that will occur in the pixel switch SW, in particular, a capacitance Cgd that will occur between the gate electrode GE and the drain electrode DE, will increase or decrease by the same ratio in each pixel switch SW.

For instance, in the above-described liquid crystal display device of the first embodiment, if a conductive layer in which the source lines SL are formed is displaced upward relative to a conductive layer in which the gate lines GL are formed, the area in which the gate electrode GE and the drain electrode DE of the pixel switch SW of the first display pixel PX1 oppose each other becomes greater. Accordingly, the capacitance Cgd also becomes greater. In this case, however, in the pixel switch SW of the second display pixel PX2, the area in which the gate electrode GE and the drain electrode DE of the pixel switch SW oppose each other becomes smaller, and accordingly, the capacitance Cgd becomes smaller. Since in display pixels PX of different Cgd values, differences will occur in the voltage applied thereto, flicker and/or burn-in phenomenon may occur.

In contrast, in the second embodiment, even when the conductive layers are displaced from each other, the capacitance Cgd of each pixel switch SW increases or decreases by the same amount. Therefore, flicker and/or burn-in phenomenon can be avoided. As a result, a liquid crystal display device of improved manufacturing yield and display quality can be provided.

As described above, in the second embodiment, the increase in the manufacturing cost of the liquid crystal display device and the decrease in the aperture ratio of the same can be suppressed, as in the first embodiment. Further, a liquid crystal display device of improved manufacturing yield and display quality can be provided.

In the liquid crystal display device of the second embodiment, the structure of the pixel switch SW is not limited to that shown in FIG. 5.

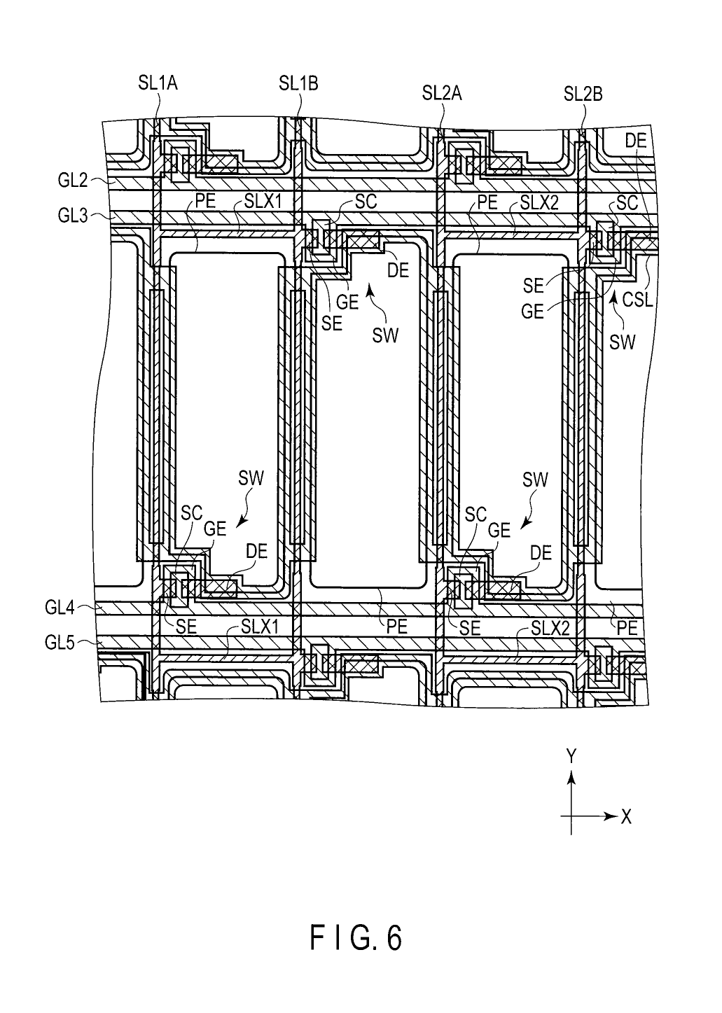

FIG. 6 is a schematic view showing another structure example of display pixels in the liquid crystal display device of the second embodiment. In this example, the structure of the pixel switch SW differs from that shown in FIG. 5. Namely, the source electrode SE of the pixel switch SW extends from the first and second source lines SLA and SLB rightward along the row, to an upper portion of the semiconductor layer SC. In the example of FIG. 6, the source electrode SE projects from one portion of each of the first and second source lines SLA and SLB near the intersections of the first and second source lines SLA and SLB and the gate line GL.

The drain electrode DE extends along the row from the upper portion of the semiconductor layer SC to the lower portion of the pixel electrode PE. Further, in the contact hole CH formed in a position in which the drain electrode DE and the pixel electrode PE overlap each other via an insulating layer, the drain electrode DE is electrically connected to the pixel electrode PE. In the upper portion of the semiconductor layer SC, the drain electrode DE is located with a predetermined space from the source electrode SE along the row.

Except for the above-described structure, the liquid crystal display device of the second embodiment has the same structure as the device shown in FIG. 5. Also in the example of FIG. 6, even when the conductive layers are displaced from each other, the capacitance Cgd of each pixel switch SW increases or decreases by the same amount. Therefore, flicker and/or burn-in phenomenon can be avoided, whereby a liquid crystal display device of improved manufacturing yield and display quality can be provided.

Namely, the increase in the manufacturing cost of the liquid crystal display device and the decrease in the aperture ratio of the same can be suppressed, as in the first embodiment. Further, a liquid crystal display device of improved manufacturing yield and display quality can be provided.

### Third Embodiment

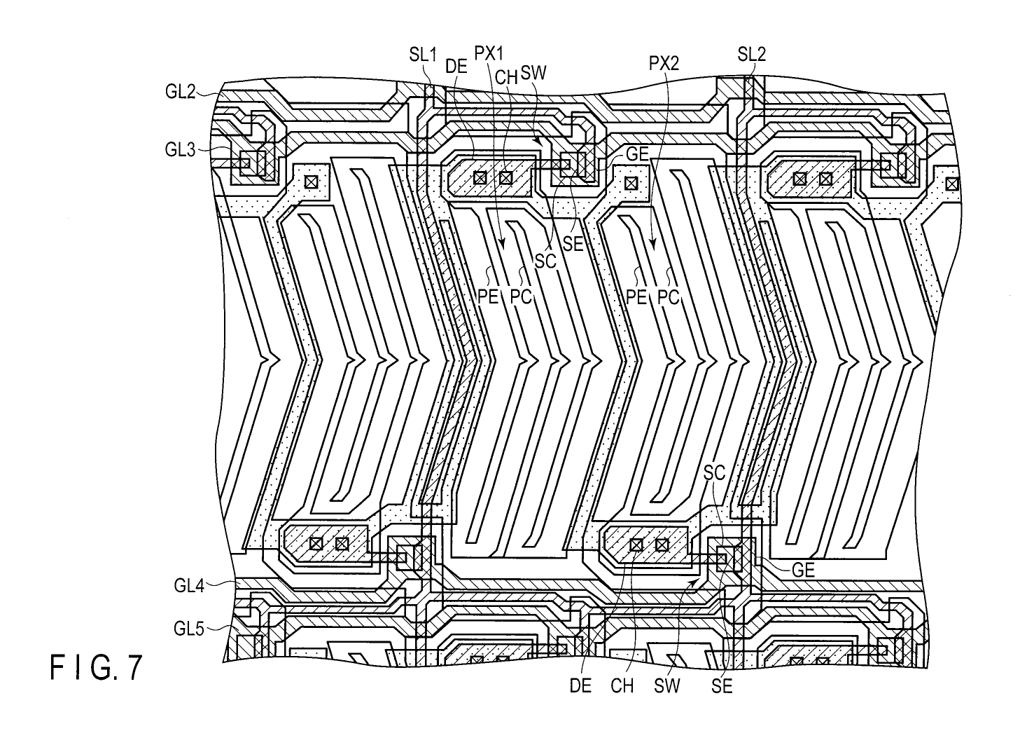

FIG. 7 is a schematic view showing a structure example of display pixels in a liquid crystal display device according to a third embodiment. In this figure, elements similar to those of FIG. 2 are denoted by corresponding reference numbers, and no detailed description will be given thereof.

The third embodiment differs from the above-described first embodiment in the structure of the pixel electrode. More specifically, the third embodiment is directed to an example of an IPS pixel in which pixel electrodes PE and common electrodes PC are arranged in a shape of a comb. The number of each of the pixel electrodes PE and the common electrodes PC included in the comb is not limited to two, but may be one.

In the display pixel PX1, the pixel switch SW connected to the source line SL1 is formed in the upper position in the figure, while in the display pixel PX2, the pixel switch SW connected to the source line SL2 is formed in the lower position in the figure. Further, in the display pixel PX1, the pixel electrodes PE are connected to the drain electrode DE of the pixel switch SW in the upper position. Similarly, in the display pixel PX2, the pixel electrodes PE are connected to the drain electrode DE of the pixel switch SW in the lower position.

As described above, also in the third embodiment, in one of each pair of adjacent pixels, the pixel switch SW is located in the upper position, and in the other pixel, the pixel switch SW is located in the lower position. Further, a auxiliary capacitive line SCL is windingly extended along three ends of each pixel electrode PE, overlaps with the drain electrode DE of the upper pixel switch SW of the display pixel PX1, and also overlaps with the drain electrode DE of the lower pixel switch SW of the display pixel PX2.

By virtue of the above structure, the increase in the manufacturing cost of the liquid crystal display device and the decrease in the aperture ratio can be suppressed, as in the first embodiment. In addition, the third embodiment can also provide the following advantage: Since it is not necessary to connect the Cs-formed portion to the drain DE via the pixel electrode PE, adverse influence of the disconnection of the pixel electrode, which may occur in the IPS pixel, can be eliminated, thereby enhancing the yield of manufacturing liquid crystal display devices. This is extremely advantageous in the liquid crystal display device using the IPS pixels.

(Modification)

The invention is not limited to the above-described embodiments.

The TFT structure of the pixel switch is not limited to an inversely-staggered type, but may be a staggered type or other types. Further, the material of the semiconductor layer is not limited to amorphous Si, but may be polysilicon, or other semiconductor materials.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
an array substrate including a plurality of pixel electrodes arranged in rows and columns;
a opposite substrate including a opposite electrode opposing the pixel electrodes; and
a liquid crystal layer held between the array substrate and the opposite substrate,
wherein the array substrate further includes:
a first gate line provided on one side of a column direction for the pixel electrodes of one row, and extending along the one row;
a second gate line provided on another side of the column direction for the pixel electrodes of one row, and extending along the one row;
source lines extending along every two of the columns between the plurality of pixel electrodes;
a first pixel switch connected between one of two pixel electrodes included in the plurality of pixel electrodes and adjacent along the one row, and one of the source lines adjacent to the one pixel electrode, the first pixel switch being turned on and off by a gate signal supplied from the first gate line;
a second pixel switch connected between the other of the two pixel electrodes, and one of the source lines adjacent to the other pixel electrode, the second pixel switch being turned on and off by a gate signal supplied from the second gate line; and
a auxiliary capacitive line opposing, via an insulating film, electrodes of the first and second pixel switches close to the pixel electrodes, and windingly extending along three sides of each of the pixel electrodes to extend along the one row.

2. The liquid crystal display device of claim 1, wherein the pixel electrodes are arranged in a shape of at least one comb, and include common electrode engaged with the pixel electrodes in the shape of the comb.

3. The liquid crystal display device of claim 1, wherein
the first pixel switch is provided on one side of the column direction with respect to the two pixel electrodes; and
the second pixel switch is provided on another side of the column direction with respect to the two pixel electrodes.

4. The liquid crystal display device of claim 1, wherein the auxiliary capacitive line overlaps with the three sides of each of the pixel electrodes.

5. The liquid crystal display device of claim 1, wherein the auxiliary capacitive line is provided to surround each of the pixel electrodes from three directions.

6. The liquid crystal display device of claim 1, wherein the auxiliary capacitive line has openings defined between adjacent ones of the pixel electrodes to overlap the source lines.

7. A liquid crystal display device comprising:
an array substrate including a plurality of pixel electrodes arranged in rows and columns;
a opposite substrate including a opposite electrode opposing the pixel electrodes; and
a liquid crystal layer held between the array substrate and the opposite substrate,
wherein the array substrate further includes:
a first gate line provided on one side of a column direction for the pixel electrodes of one row, and extending along the one row;
a second gate line provided on another side of the column direction for the pixel electrodes of one row, and extending along the one row;
a first source line and a second source line extending along the columns on opposite sides of one of two pixel electrodes included in the plurality of pixel electrodes and adjacent along the one row, the first and second source lines receiving a common video signal;
a first pixel switch connected between one of the two pixel electrodes and the first source line to be turned on and off by a gate signal supplied from the first gate line;
a second pixel switch connected to the other of the two pixel electrodes and the second source line to be turned on and off by a gate signal supplied from the second gate line; and
a auxiliary capacitive line opposing, via an insulating film, electrodes of the first and second pixel switches close to the pixel electrodes, and windingly extending along three sides of each of the pixel electrodes to extend along the one row.

8. The liquid crystal display device of claim 7, wherein the first and second source lines include a connection by which the first and second source lines are electrically connected.

9. The liquid crystal display device of claim 7, wherein
each of the first and second pixel switches includes a semiconductor layer provided on one side of a row direction in which the pixel electrodes are arranged, a gate electrode extending from the first or second gate line along the columns and provided on a lower portion of the semiconductor layer, a source electrode provided on an upper portion of the semiconductor layer and connected to the first or second source line, and a drain electrode provided on the upper portion of the semiconductor layer and connected to a corresponding pixel electrode; and
the drain electrode extends along the one row between a lower portion of the corresponding pixel electrode and the upper portion of the semiconductor layer.

10. The liquid crystal display device of claim 7, wherein
the first pixel switch is provided on one side of the column direction with respect to the two pixel electrodes; and
the second pixel switch is provided on another side of the column direction with respect to the two pixel electrodes.

11. The liquid crystal display device of claim 7, wherein the auxiliary capacitive line overlaps with the three sides of each of the pixel electrodes.

12. The liquid crystal display device of claim 11, wherein the auxiliary capacitive line is provided to surround each of the pixel electrodes from three directions.

13. The liquid crystal display device of claim 7, wherein the auxiliary capacitive line has openings defined between adjacent ones of the pixel electrodes to overlap the first and second source lines.
